(19) United States
(12) Patent Application Publication
(10) Pub. No.: US 2012/0278333 A1
(43) Pub. Date: Nov. 1, 2012

(54) COMPUTERIZED DATA SET SEARCH METHOD

(75) Inventors: Arun C. Ramachandran, Nadu (IN); Lakshmanan Velusamy, Nadu (IN)

(73) Assignee: INTERNATIONAL BUSINESS MACHINES CORPORATION, Armonk, NY (US)

(21) Appl. No.: 13/452,850

(22) Filed: Apr. 21, 2012

Related U.S. Application Data
(63) Continuation of application No. 13/095,772, filed on Apr. 27, 2011.

(51) Int. Cl. G06F 17/30

(52) U.S. Cl. 707/741; 707/E17.002; 707/E17.014

(57) ABSTRACT

A method provides computerized searching of a data set. A method determines the location of an item in a contiguous data set including a plurality of items, the data set is stored in a computer system, and the method assigns a numeric value to each of the plural items in the data set. A least squares polynomial may be created for the data set using ordered pairs of (x, y), wherein x is the assigned numeric value of the item the data set and y is the location of the item in the data set. A command is received to search for the location of a target item in the data set, and a calculated target item location in the data set is generated using a target item assigned numeric value and the least squares polynomial.

### CROSS-REFERENCES TO RELATED APPLICATIONS

This application is a continuation of U.S. patent application Ser. No. 13/095,772, which is incorporated herein by reference in its entirety for all purposes.

### BACKGROUND

The present invention relates to generally to the field of computerized data set search methods, computer program products and/or computer systems. Specifically, the present invention provides computerized data set search methods using the principle of least squares to search for the location of an item in a contiguous data set.

Searching has always been a key area of interest and a lot of search algorithms have been proposed. Exemplary criterion of a successful search of an item in a data set may include search efficiency, or the time required for the search, and search accuracy. An example of a data set search includes a binary search with n elements, having an average time complexity, or amount of time taken by an algorithm to run as a function of the size of the input to the problem, of O(log n)−1.

### BRIEF SUMMARY

According to one embodiment of the present invention, a method, implemented in a computer system, for determining the location of an item in a contiguous data set including a plurality of items, the data set stored in the computer system, may include assigning a numeric value to each of the plurality of items in the data set. A least squares polynomial may be created for the data set using ordered pairs of (x, y), wherein x is the assigned numeric value of the item the data set and y is the location of the item in the data set. A command may be received to search for the location of a target item in the data set, and a calculated target item location in the data set may be generated using a target item assigned numeric value and the least squares polynomial.

According to another embodiment of the present invention, a method, implemented in a computer system, for determining the location of an item in a contiguous data set including a plurality of items, the data set stored in the computer system, may include creating a least squares polynomial for the data set using ordered pairs of (x, y), wherein x is an assigned numeric value of the item the data set and y is the location of the item in the data set. A request may be received to search for the location of a target item in the data set. A calculated target item location in the data set may be generated using a target item assigned numeric value and the least squares polynomial, and the target item assigned numeric value may be compared with the assigned numeric value of the item at the calculated target item location to determine an output target item location.

### BRIEF DESCRIPTION OF THE SEVERAL VIEWS OF THE DRAWINGS

FIG. 1 is a pictorial representation of an example of a computer system in which illustrative embodiments may be implemented.

FIG. 2 is a block diagram of an example of a computer in which illustrative embodiments may be implemented.

FIG. 3 is an example of a method of a computerized data set search method.

FIG. 4 is an example of a method of a computerized data set search method.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

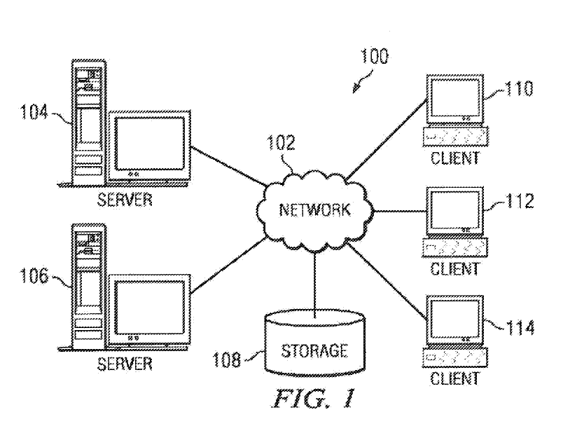

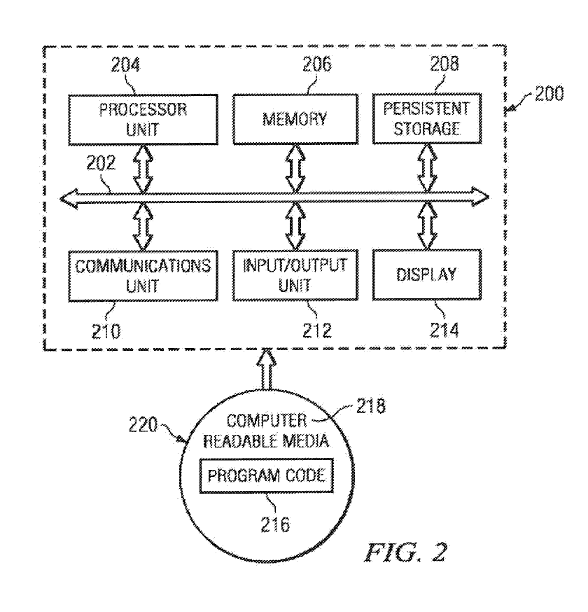

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a computer system, indicated generally at 100, and including a network of computers in which illustrative embodiments may be implemented. Computer system 100 may contain a network 102, which is the medium used to provide communications links between various devices and computers connected together within computer system 100. Network 102 may include connections, such as wire, wireless communication links, or fiber optic cables.

In the depicted example, a server 104 and a server 106 may connect to network 102 along with a storage unit 108. In addition, a first client computer 110, a second client computer 112, and a third client computer 114 may connect to network 102. Client computers 110, 112, and 114 may be, for example, personal computers or network computers. In the depicted example, server 104 may provide data, such as boot files, operating system images, and/or software applications to client computers 110, 112, and 114. Client computers 110, 112, and 114 are clients to server 104 in this example. Computer system 100 may include additional servers, clients, and other devices not shown, or may include fewer devices than those shown.

In the depicted example, network 102 may be or may include the Internet. Computer system 100 also may be implemented with a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer system, such as a server or a client computer, in which computer-usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 may serve to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs may be located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code. The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that maybe present in communications fabric 202.

In one example of a computerized data set search, one or more polynomials may be constructed based on a given data set including one or more items. In some embodiments, the data set may include a contiguous data set. Additionally and/or alternatively, the data set may be sorted and/or a data base for which polynomial construction is mostly one time, for example a dictionary. Each item in the given data set may be transformed into a numeric value. The data set may include a predetermined memory size and/or number of items. The location of the last item in the data set may also be referred to as a predetermined maximum location value or predetermined maximum value.

The numeric value, also referred to as (x), and the position of item in the data set, also referred to as (y), may be used as inputs, also referred to as pairs (x,y), to create a least squares polynomial by using principle of least squares. The degree of the least squares polynomial may vary, for example some embodiments may include a least squares polynomial of a first degree, a second degree, a third degree or higher than third degree. The degree of the least squares polynomial may be dependent on the size of the data set.

Searching for a target item in the data set may include entering the assigned numeric value of the target item (x) as input to the least squares polynomial. The output of the least squares polynomial may give the exact or nearest location of the target item in the data set, also referred to as a calculated target item location (y). By taking the degree of the least squares polynomial to a high degree, such as the third degree, the searching can be improved to get efficient results, or average time complexity, as far as O (1).

The following is a description of the Principle of Least Squares:

Suppose x and y, are known to obey a “straight line law” of the form y=a+bx, where a and b are constants to be found. In an experiment to test this law, let n pairs of values be (xᵢ,yᵢ), where i=1, 2, 3 . . . n.

If the values xᵢ are assigned values, they are likely to be free from error. The observed values, yᵢ will be subject to experimental error. For the straight line of “best fit”, the sum of the squares of the y-deviations, from the line, of all observed points is a minimum. Using partial differentiation it may be shown that

$${\sum }_{i = 1}^{n} {y}_{i} = n a + b {\sum }_{i = 1}^{n} {x}_{i} and , \\ {\sum }_{i = 1}^{n} {x}_{i} {y}_{i} = a {\sum }_{i = 1}^{n} {x}_{i} + b {\sum }_{i = 1}^{b} {x}_{i}^{2}$$

The above two equations are know as normal equations. Eliminating a and b in turn,

$$n \sum {x}^{2} - {( \sum x )}^{2} and , b = \frac{n \sum x y - \sum x \cdot \sum y}{n \sum {x}^{2} - {( \sum x )}^{2}}$$

The above two values of a and b may be used to get the polynomial as y=a+bx.

Additionally, and/or alternatively, for larger datasets, a second or third degree curve may be fitted by the principle of least squares. The normal equations of second degree curve are as follows.

aΣx⁴+bΣx³+cΣx²=Σx²y

aΣx³+bΣxᵢ²+cΣxᵢ=Σxy

aΣx²+bΣx+nc=Σy

As noted above, the calculated target item location (y) may include an exact or near location of the target item in the data set. In some embodiments, the calculated target item location may include an output target item location. The output target item location may be the location outputted or displayed to a user. Additionally and/or alternatively, the calculated target item location may be further processed, prior to display to the user, to obtain the output target item location.

For example, the calculated target item location may be processed to obtain the output target item location using one or more of the following steps:
1. If the calculated target item location is greater that the memory size, or the predetermined maximum value, then the output target item location may be assigned to be the position of the last item stored in the data set, the predetermined maximum value.
2. If the target item is present at the calculated target item location, then the output target item location may be assigned to be the calculated target item location.
3. If the target item is not present at the calculated target item location, then
   a. If the item at the calculated target item location is greater than the target item, then search the data set for the location of the target item in a backward direction from the calculated target item location.
   b. If the item at the calculated target item location is less than the target item, then search the data set for the location of the target item in a forward direction from the calculated target item location.
   c. If the target item is not present after searching in both directions, then return an “Item not found” message to the user or return the calculated target item location to the user.

An exemplary pseudocode may include some or all of the following pseudocode:

```
Polycurve( )
      item= polycurve(sitem)
      count=0;
Search( item)
{
      if(valx[locy] > memsize)
            locy=finloc
      else if(valx[locy] < memsize)
            locy=startloc
      if(Success=match (item,valx [locy]))
            ++count
      if(Success)
      {
            return count
            break
      }
      if( valx[item]=sitem)
            call match(sitem,valx[item])
      else if(sitem > valx[item})
            call match(sitem,valx [++item] )
      else
            call match(sitem,valx[−−item])
      writemsg(NO SUCH ITEM FOUND)
}
```

Using the above pseudocode, a variable count may keep track of the count of the total number of searches. The variable item is the return value of location of y for the search item sitem. The maximum feasible value of location y is given by memsize. The function match( ) may match the search item with the array of elements in x and may return a variable Success.

The following is an exemplary evaluation of an example of a computerized data search method and results using the sorted data set given in Table I.

A line may be fitted between the items in the data set (x) and the location of the items in the data set (y). A least squares polynomial may be constructed using the principle of least squares by taking as input all the given pairs of x and y. In this example, using the principle of least squares for an equation of a third degree, the least squares polynomial is:

Calculated location (y)=−0.000001x³+0.000020x²+0.194049x+0.305530→(1)

Case i: target item=20.

Substituting 20 as the value of x to the above least squares polynomial results in a calculated target item location y=4.18651, which may be rounded to 4. As shown in Table 1, 4 is the exact location of the item 20 and, therefore, the output target item location may be 4. The search order of case i may be O (1).

Case ii: target item=69

Substituting 69 as the value of x to the above least squares polynomial results in a calculated target item location y=13.461622, which may be rounded to 13. 13 is not the exact location of the target in the data set. The target item 69 may be compared with the item number at the calculated target item location 13, which is 80. Because the target item value 69 is less than 80, we search for the target item 69 in a backward direction from the calculated target item location 13 to get a new calculated target item location as 11. The search order of case ii may be O (2)).

Case iii: target item=250

Substituting 250 as the value of x to the above least squares polynomial results in a calculated target item location y=34.44278, which may be rounded to 34. 34 is greater than the location of the last item in the data set (29). The output target item location may be assigned to be location of the last item in the data set, which is 29. The item at the last time in the data set is 250, which is the target item. Accordingly, the search order of case iii is (O (1)).

TABLE I
Data items and data item locations in the memory.

| | | Order of | |
|---|---|---|---|
| | | searching using | |
| | | an example of | |
| | Location | computerized | Order of |
| Item | in data set | data set | searching using |
| (x) | (y) | searching | Binary Search |
| 1 | 0 | 1 | 5 |
| 3 | 1 | 1 | 4 |
| 9 | 2 | 1 | 5 |
| 11 | 3 | 2 | 3 |
| 20 | 4 | 1 | 5 |
| 23 | 5 | 1 | 4 |
| 24 | 6 | 2 | 5 |
| 28 | 7 | 2 | 2 |
| 39 | 8 | 1 | 4 |
| 49 | 9 | 2 | 5 |
| 58 | 10 | 2 | 3 |
| 69 | 11 | 2 | 5 |
| 73 | 12 | 3 | 4 |
| 80 | 13 | 3 | 5 |
| 81 | 14 | 2 | 1 |
| 82 | 15 | 2 | 5 |
| 84 | 16 | 1 | 4 |
| 90 | 17 | 1 | 5 |
| 95 | 18 | 1 | 3 |
| 96 | 19 | 2 | 5 |
| 97 | 20 | 3 | 4 |
| 98 | 21 | 4 | 5 |
| 109 | 22 | 3 | 2 |
| 120 | 23 | 3 | 5 |
| 140 | 24 | 1 | 4 |
| 150 | 25 | 1 | 5 |
| 169 | 26 | 2 | 3 |
| 190 | 27 | 2 | 5 |
| 215 | 28 | 2 | 4 |
| 250 | 29 | 1 | 5 |

The test results for varying target item inputs (x) from numbers ranging from 1 to n (n=100), indicate that the maximum order of the exemplary search may be less than the O(log n). The average order of the exemplary search may be less than that of binary search. For a uniformly distributed data set, the time complexity of the exemplary search may be 1.

In comparison, with n elements, the average time complexity of a binary search is of the O(log n)−1. Out of the n elements n/2 elements have a time complexity of O(log n).

In some embodiments, given a randomly given dataset of 10 items a user may be able to achieve search results of up to O (1) for nearly 9 of the 10 items and an O (2) for the remaining item. Additionally and/or alternatively, some embodiments may provide an improved performance when compared with a binary search for which the order of searching increases as the length of the dataset increases in the ratio of log (n).

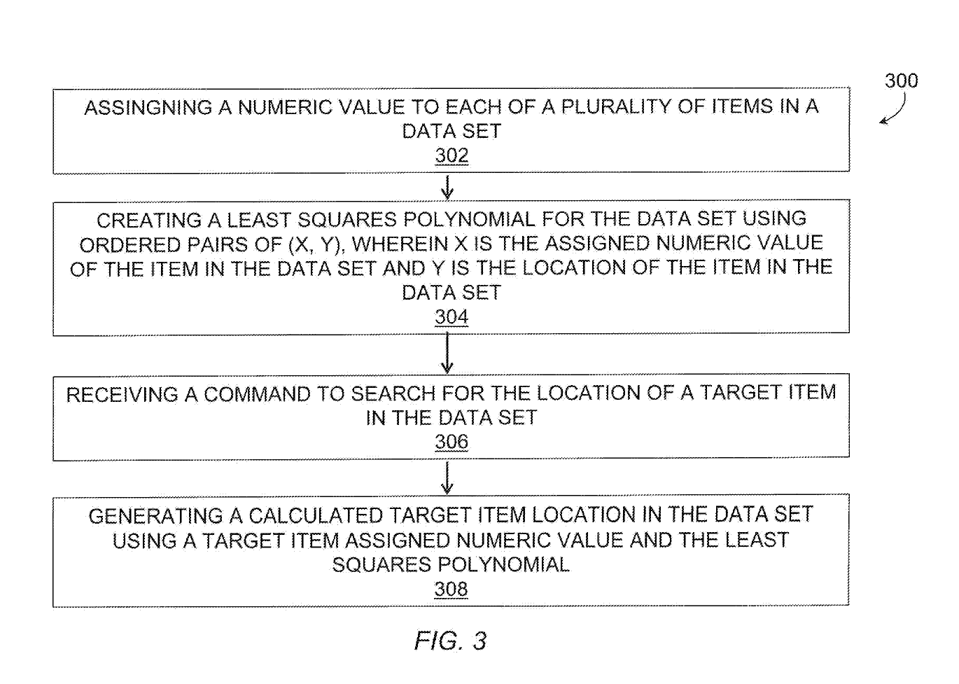

Referring now to FIG. 3, an example of a method, implemented in a computer system, for determining the location of an item in a contiguous data set including a plurality of items, the data set stored in the computer system is shown. While FIG. 3 shows exemplary steps of a method according to one embodiment, other embodiments may omit, add to, and/or modify any of the steps shown in that figure. In step 302, a numeric value may be assigned to each of the plurality of items in the data set. In step 304, a least squares polynomial may be created for the data set using ordered pairs of (x, y), wherein x is the assigned numeric value of the item the data set and y is the location of the item in the data set. The least squares polynomial created may include a second degree poly nominal or a third degree polynomial. Alternatively, the polynomial may be linear or include a greater than third degree polynomial.

In step 306, a command may be received to search for the location of a target item in the data set, and, in step 308, a calculated target item location in the data set may be generated using a target item assigned numeric value and the least squares polynomial. Method 300 may include displaying the output target item location.

Method 300 may include other steps. For example, method 300 may include comparing the target item assigned numeric value with the assigned numeric value of the item at the calculated target item location to determine an output target item location. If the target item assigned numeric value is greater than the assigned numeric value of the item at the calculated target item location, then method 300 may include searching the data set for the location of the target item in a backward direction from the calculated target item location. Additionally and/or alternatively, if the calculated target item location is greater than a predetermined maximum value, then method 300 may include assigning the output target item location to be the predetermined maximum value. Additionally and/or alternatively, if the target item assigned numeric value is the same as the assigned numeric value of the item at the calculated target item location, then method 300 may include assigning the output target item location to be the calculated target item location. Additionally and/or alternatively, if the target item assigned numeric value is less than the assigned numeric value of the item at the calculated target item location, then method 300 may include searching the data set for the location of the target item in a forward direction from the calculated target item location.

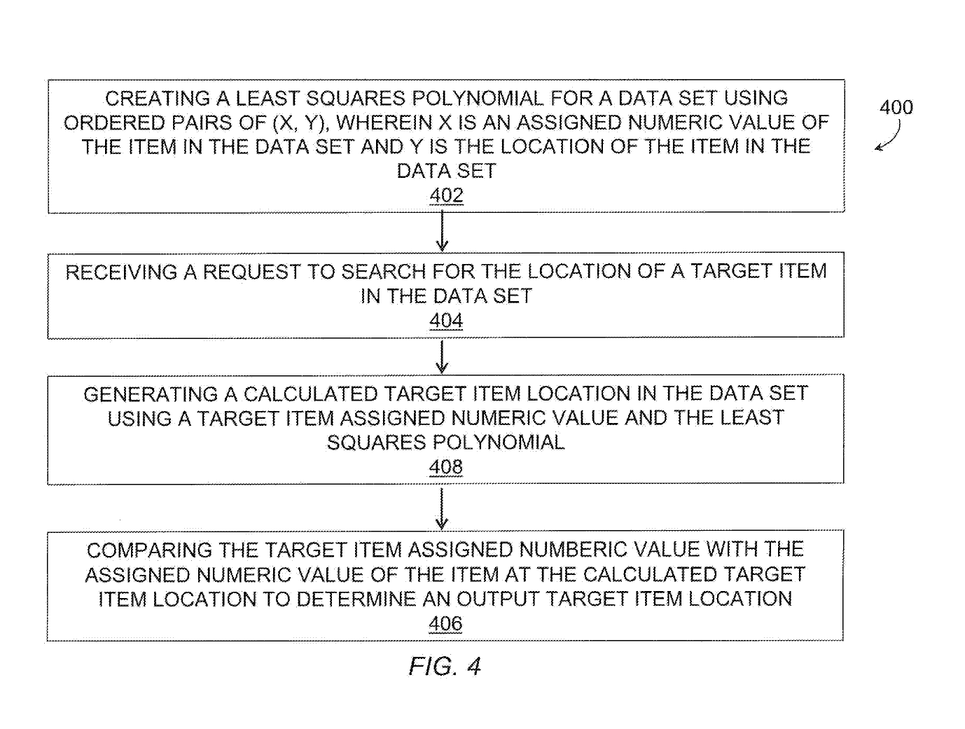

Referring now to FIG. 4, a further example of a method, implemented in a computer system, for determining the location of an item in a contiguous data set including a plurality of items, the data set stored in the computer system is shown. While FIG. 4 shows exemplary steps of a method according to one embodiment, other embodiments may omit, add to, and/or modify any of the steps shown in that figure. In step 402, a least squares polynomial may be created for the data set using ordered pairs of (x, y), wherein x is an assigned numeric value of the item the data set and y is the location of the item in the data set. In step 404, a request may be received to search for the location of a target item in the data set. In step 406, a calculated target item location in the data set may be generated using a target item assigned numeric value and the least squares polynomial.

In step 408, the target item assigned numeric value may be compared with the assigned numeric value of the item at the calculated target item location to determine an output target item location. Method 400 may further include assigning a numeric value to each of the plurality of items in the data set.

Method 400 may include other steps. For example, if the target item assigned numeric value is greater than the assigned numeric value of the item at the calculated target item location, then method 400 may include searching the data set for the location of the target item in a backward direction from the calculated target item location. Additionally and/or alternatively, if the calculated target item location is greater than a predetermined maximum value, then method 400 may include assigning the output target item location to be the predetermined maximum value. Additionally and/or alternatively, if the target item assigned numeric value is the same as the assigned numeric value of the item at the calculated target item location, then method 400 may include assigning the output target item location to be the calculated target item location. Additionally and/or alternatively, if the target item assigned numeric value is less than the assigned numeric value of the item at the calculated target item location, then method 400 may include searching the data set for the location of the target item in a forward direction from the calculated target item location.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, implemented in a computer system, for determining the location of an item in a contiguous data set including a plurality of items, the data set stored in the computer system, the method comprising:
assigning a numeric value to each of the plurality of items in the data set;
creating a least squares polynomial for the data set using ordered pairs of (x, y), wherein x is the assigned numeric value of the item the data set and y is the location of the item in the data set;
receiving a command to search for the location of a target item in the data set; and
generating a calculated target item location in the data set using a target item assigned numeric value and the least squares polynomial.

2. The method of claim 1, further comprising comparing the target item assigned numeric value with the assigned numeric value of the item at the calculated target item location to determine an output target item location.

3. The method of claim 2, wherein if the target item assigned numeric value is greater than the assigned numeric value of the item at the calculated target item location, then searching the data set for the location of the target item in a backward direction from the calculated target item location.

4. The method of claim 2, wherein if the calculated target item location is greater than a predetermined maximum value, then assigning the output target item location to be the predetermined maximum value.

5. The method of claim 2, wherein if the target item assigned numeric value is the same as the assigned numeric value of the item at the calculated target item location, then assigning the output target item location to be the calculated target item location.

6. The method of claim 2, wherein if the target item assigned numeric value is less than the assigned numeric value of the item at the calculated target item location, then searching the data set for the location of the target item in a forward direction from the calculated target item location.

7. The method of claim 2, further comprising displaying the output target item location.

8. The method of claim 1, wherein creating a least squares polynomial for the data set includes creating a third degree order least squares polynomial.

9. The method of claim 1, wherein creating a least squares polynomial for the data set includes creating a second degree order least squares polynomial.

10. A method, implemented in a computer system, for determining the location of an item in a contiguous data set including a plurality of items, the data set stored in the computer system, the method comprising:
creating a least squares polynomial for the data set using ordered pairs of (x, y), wherein x is an assigned numeric value of the item the data set and y is the location of the item in the data set;
receiving a request to search for the location of a target item in the data set;
generating a calculated target item location in the data set using a target item assigned numeric value and the least squares polynomial; and
comparing the target item assigned numeric value with the assigned numeric value of the item at the calculated target item location to determine an output target item location.

11. The method of claim 10, further comprising assigning a numeric value to each of the plurality of items in the data set.

12. The method of claim 10, wherein if the target item assigned numeric value is greater than the assigned numeric value of the item at the calculated target item location, then searching the data set for the location of the target item in a backward direction from the calculated target item location.

13. The method of claim 10, wherein if the calculated target item location is greater than a predetermined maximum value, then assigning the output target item location to be the predetermined maximum value.

14. The method of claim 10, wherein if the target item assigned numeric value is the same as the assigned numeric value of the item at the calculated target item location, then assigning the output target item location to be the calculated target item location.

15. The method of claim 10, wherein if the target item assigned numeric value is less than the assigned numeric value of the item at the calculated target item location, then searching the data set for the location of the target item in a forward direction from the calculated target item location.
